(19) United States
(12) Patent Application Publication
(10) Pub. No.: US 2026/0010474 A1
(43) Pub. Date: Jan. 8, 2026

(54) APPARATUS WITH LOCATION-BASED MANAGEMENT MECHANISM AND METHODS FOR OPERATING THE SAME

(71) Applicant: Micron Technology, Inc., Boise, ID (US)

(72) Inventors: Marco Onorato, Concorezzo (IT); Luca Porzio, Casalnuovo Di Napoli (IT); Tomer Eliash, Sunnyvale, CA (US)

(21) Appl. No.: 19/261,660

(22) Filed: Jul. 7, 2025

Related U.S. Application Data
(60) Provisional application No. 63/668,769, filed on Jul. 8, 2024.

(51) Int. Cl. G06F 12/06; G01S 19/01

(52) U.S. Cl. CPC G06F 12/0646; G01S 19/01

(57) ABSTRACT

Disclosed herein are methods, apparatuses and systems related to adjusting memory operations according to context. The apparatus may be configured to obtain a current location and adjust a processing voltage according to the current location.

### CROSS-REFERENCE TO RELATED APPLICATION(S)

The present application claims priority to U.S. Provisional Patent Application No. 63/668,769, filed Jul. 8, 2024, the disclosure of which is incorporated herein by reference in its entirety.

### TECHNICAL FIELD

The disclosed embodiments relate to devices, and, in particular, to semiconductor memory devices with location-based management mechanism and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. However, the performance or characteristics of the memory devices can be affected by ambient temperatures.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is an illustration of a control map in accordance with an embodiment of the present technology.

FIG. 3 is a flow diagram illustrating an example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for dynamically adjusting operating parameters according to changes in the operating environment. For example, a memory system can obtain contextual data, such as device location, ambient temperatures, trends thereof, and/or other related data, and adjust internal operations accordingly.

The memory system can be implemented within a variety of larger/encompassing devices or systems. Accordingly, the deployed operating environment and the corresponding effects on the memory system's performance can differ vastly across applications. One such environmental condition can include ambient temperature. The ambient temperature affects the operating temperature of the memory system, thereby affecting operating performance. For example, changes in the system temperature can affect the threshold voltage of memory cells due to the influence of temperature on the physical characteristics of the materials used in the memory cells. As the temperature changes, the conductivity and other electrical properties of the memory cells can also change.

Some applications of the memory system can be more susceptible to temperature changes than other applications. For example, automotive applications can often present above average operating temperatures (e.g., higher maximum and/or lower minimum temperatures, faster changes, etc.). For example, depending on the location of the memory system within the vehicle, the operating environment may be influenced by engine temperature, cabin temperature, or a combination thereof. For automobiles, the memory system may experience ambient temperatures as low as −20° C. or below (e.g., Alaska, Northern Europe, Russia, Southern areas of Chile, Argentina, polar regions, etc.) when the vehicle ignition is off during colder seasons. For the same vehicle, the ambient temperature of the memory system can rise up to 100° C. or higher during warmer seasons, during vehicle travel/operation, cabin conditions, or the like.

Moreover, given the geographical mobility associated with vehicle applications, the ambient temperatures (e.g., temperatures outside of the vehicle) and the resulting influence on the operating temperatures may vary and change unexpectedly. For example, the vehicle can travel or otherwise can be moved between polar regions and warmer regions, such as tropical or equatorial regions. Also, some vehicles (e.g., aircrafts, automobiles, etc.) can be subject to vertical displacements or altitude changes that present significant changes in ambient temperatures.

To adapt to and manage such external influences, embodiments of the technology described herein can include a context management mechanism that obtains and adjusts for context data. The context management mechanism can interact with a system host to obtain the context data that includes current location data (e.g., GPS coordinates), altimeter readings, operating durations, time stamps (e.g., seasonal indicators), ambient temperature readings, vehicle identifiers, and/or the like. Based on the context data, the context management mechanism can adjust control parameters, such as various trim settings for adjusting processing levels (e.g., threshold voltages, read levels, write voltages, rewrite/refresh timing, etc.), according to the operating environment.

Accordingly, the context management mechanism can provide a dynamic and more accurate estimate of the operating environment for the memory system. The improved estimate and the corresponding operational adjustments can lower errors/failures, reduce remedial operations and the corresponding power/time, along with other benefits. For example, the memory system can improve a trimming scheme that accounts for internal operations/conditions as well as accurate external conditions. Reduced power expenditure and resource consumption can further prevent structural damage to the memory cells, thereby prolonging the overall life of the memory system.

### Example Environment

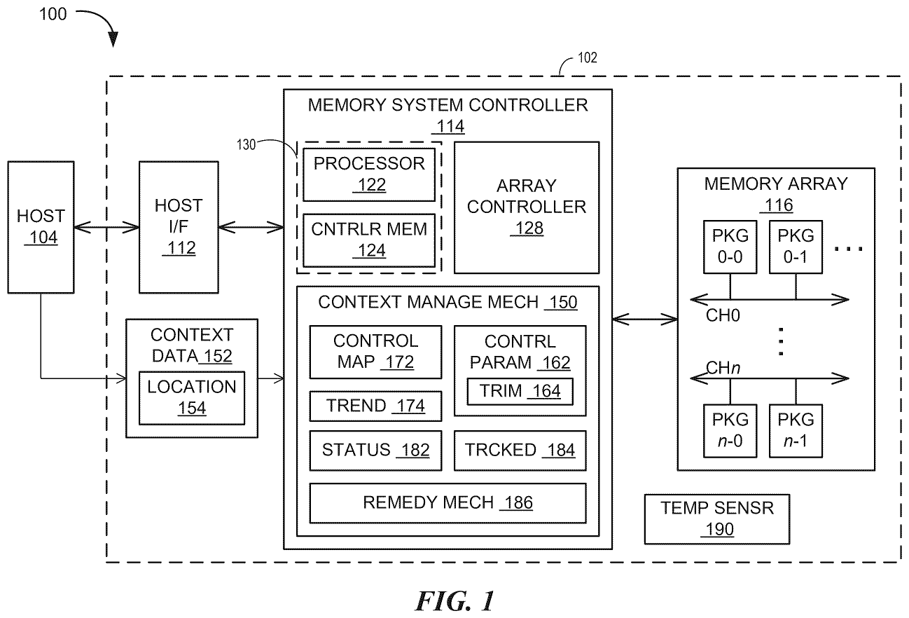

FIG. 1 is a block diagram of a computing system 100 in accordance with an embodiment of the present technology. The computing system 100 can include a personal computing device/system, an enterprise system, a mobile device, a server system, a database system, a distributed computing system, or the like. In some embodiments, the computing system 100 can include a vehicle management system, such as for operating an automobile, a watercraft, an aircraft, an autonomous vehicle, or the like.

The computing system 100 can have a memory system 102 coupled to a host device 104. The host device 104 can include one or more system processors that can write data to and/or read data from the memory system 102. For example, the host device 104 can include an upstream central processing unit (CPU). Also, for example, the host device 104 can be configured to control operation of a corresponding structure or system, such as other components (not shown) of the computing system 100 or structures operably coupled to the computing system (e.g., the vehicle or subsystems therein).

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, an SSD system, an SD card, or the like. In some embodiments, the memory system 102 can correspond to a Universal Flash Storage (UFS) device.

The memory system 102 can include a host interface 112 (e.g., buffers, transmitters, receivers, and/or the like) configured to facilitate communications with the host device 104. The host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104. In some embodiments, the host interface 112 can be configured to implement the UFS protocols in communicating with the host device 104.

The memory system 102 can further include a memory system controller 114 (also called a micro controller) and a memory array 116. The memory array 116 can include memory cells that are configured to store a unit of information. The memory system controller 114 can be configured to control the overall operation of the memory system 102, including the operations of the memory array 116.

In some embodiments, the memory array 116 can include a set of NAND Flash devices, packages, dies, or the like. Each of the packages can include a set of memory cells that each store data in a charge storage structure. The memory cells can include, for example, floating gate, charge trap, phase change, ferroelectric, magnetoresitive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate the Vt of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 23) data states to store three bits of data, and quad level cells (QLCs) may be programmed to one of 16 (i.e., 24) data states to store four bits of data.

Such memory cells may be arranged in rows (e.g., each corresponding to a word line 143) and columns (e.g., each corresponding to a bit line). The arrangements can further correspond to different groupings for the memory cells. For example, each word line can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

While the memory array 116 is described with respect to the memory cells, it is understood that the memory array 116 can include other components (not shown). For example, the memory array 116 can also include other circuit components, such as multiplexers, decoders, buffers, read/write drivers, address registers, data out/data in registers, etc., for accessing and/or programming (e.g., writing) the data and for other functionalities.

As described above, the memory system controller 114 can be configured to control the operations of the memory array 116. The memory system controller 114 can include a processor 122, such as a special purpose logic circuitry (e.g., a field programmable gate array (FPGA), an application specific integrated circuit (ASIC), etc.), a microprocessor, or other suitable processor. The processor 122 can execute instructions encoded in hardware, firmware, and/or software (e.g., instructions stored in controller embedded memory 124 to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In controlling the operations of the memory system 102, the memory system controller 114 (via, e.g., the processor 122, the embedded memory 124, and/or the array controller 128) can implement a Flash Translation Layer (FTL) 130. The FTL 130 can include a set of functions or operations that provide translations for the memory array 116 (e.g., the Flash devices therein). For example, the FTL 130 can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL 130 can include a garbage collection function that extracts useful data from partially filed units (e.g., memory blocks) and combines them to a smaller set of memory units. The FTL 130 can include other functions, such as wear-leveling, bad block management, concurrency (e.g., handling concurrent events), page allocation, error correction code (e.g., error recovery), or the like.

The memory system 102 can include a context management mechanism 150 (e.g., software instructions, firmware, dedicated circuit, or the like) configured to adapt and manage internal operations of the memory system 102 according to contextual information, such as conditions or environmental factors associated with the encompassing structure/system. As an illustrative example, the memory system 102 can be implemented within or as a part of a vehicle (e.g., an automobile, an aircraft, a watercraft, etc.). For such applications, the context management mechanism 150 can be configured to adapt to or account for changes in the ambient temperature as caused by geographic displacement or travel, altitude changes, seasonal changes, or the like. Also, the context management mechanism 150 can be configured to account for an arrangement of the memory system 102 relative to the vehicle structure, such as proximity to the engine, proximity or inclusion in temperature regulated environment (e.g., cabin).

The context management mechanism 150 can be configured to communicate (e.g., via the processor 122, the host interface 112, or a combination thereof) with the host device 104 to obtain context data 152. The context data 152 can include information describing the conditions or environmental factors associated with the encompassing structure/system. For example, the host device 104 can correspond to a vehicle management system, and the context data 152 can include the ambient temperature, altitude reading, time stamp, vehicle identification (e.g., make and model of the encompassing vehicle), or the like. In some embodiments, the context data 152 can include a location data 154 of the vehicle. The location data 154 can represent a current location (e.g., GPS data) of the vehicle.

The context management mechanism 150 can communicate with the host device 104 according to a predetermined protocol/timing. In some embodiments, the host device 104 can push the context data 152 to the memory system 102 at predetermined timing (e.g., once a day at one of predetermined times) or according to predetermined conditions (e.g., a continuous travel distance, an engine-on duration, a temperature reading, or a combination thereof meeting or passing a threshold). Similarly, the context management mechanism 150 can be configured to request and receive the context data 152 according to the predetermined timings/conditions.

The context management mechanism 150 can adjust one or more control parameters 162 based on the context data 152. The control parameters 162 can include signals, settings, bits, commands, or the like that adjust one or more operating aspects or details. For example, the control parameters 162 can include trim settings 164 for adjusting operating levels, such as threshold voltages, read level voltages, write voltages, or the like. Effectively, the context management mechanism 150 can account for the ambient and operating temperatures and change the threshold voltages used for operation of the memory system 102 and/or the memory array 116. The control parameters 162 can further include controls for operating mode settings, recovery (e.g., rewrite or refresh) timing, or the like.

The context management mechanism 150 can adjust the control parameters 162 according to a control map 172 (e.g., a look up table (LUT), an equation, or the like) that identifies predetermined relationships or patterns between various context data values and control parameter values/settings. For example, the control map 172 can include a set of locations (e.g., GPS coordinate ranges) and/or related ambient temperature ranges having predetermined/corresponding control parameter settings/values. The context management mechanism 150 can determine the control parameter 162 that corresponds to the received context data 152 using the control map 172.

In some embodiments, the context management mechanism 150 can be configured to track and maintain a context trend 174 that represents a history or a trend associated with the context data 152, the control parameter 162, or a combination thereof. The context management mechanism 150 can use a running window, a buffer, or the like for tracking the context trend 174. Further, the context management mechanism 150 can include a predetermined mechanism that compresses the previous/stored context data, implements thresholding or hysteresis control, computes a trend based on the context data, or a combination thereof.

During operation of the memory system 102, such as while the control parameters 162 are being implemented, the context management mechanism 150 can maintain an operating status 182. The operating status 182 can represent whether the actual/detected real-time context-related data matches an estimated condition associated with the control parameters 162. For example, the context management mechanism 150 can use the location data 154 to effectively estimate ambient temperatures and generate an estimate of an operating temperature range using the control map 172. The context management mechanism 150 can select the control parameters 162 according to the estimated operating range. In addition, during operation of the memory system 102, the context management mechanism 150 can obtain real-time temperatures using sensors (not shown) onboard the memory system 102. The context management mechanism 150 control the operating status 182 based on comparing the real-time temperature readings to a predetermined set of thresholds, the estimated ranges, or a combination thereof. In other words, the context management mechanism 150 can use the operating status 182 to indicate when the internal operating conditions of the memory system 102 (e.g., at the memory array 116) falls outside of a predetermined operating range, an estimated temperature range, or a combination thereof.

When the operating status 182 indicates such abnormal or unexpected conditions, the context management mechanism 150 can track or maintain tracked operations 184 that include memory operations (e.g., by tracking the corresponding addresses) that occurred under such abnormal/unexpected conditions. For example, the context management mechanism 150 use the tracked operations 184 to identify the write operations and the corresponding addresses that occurred while the operating status 182 is active, such as when the internal temperatures are outside of a predetermined range (e.g., above 100° C. or below −10° C. or −20° C.) or an operating temperature range associated with the location data 154.

The context management mechanism 150 can further include a remedy mechanism 186 that can be utilized to reinforce or strength the data affected by the tracked operations 184. For example, the remedy mechanism 186 can include a rewrite, a transfer, a refresh, or the like. The remedy mechanism 186 can include performing such operation on the tracked operations 184 as soon as the operating status 182 returns to default condition.

The memory system 102 can further include an internal temperature sensor 190 that measures the operating temperature of the memory array 116, the memory system controller 114, the host interface 112, or a combination thereof. The memory system 102 can receive outputs from the internal temperature sensor 190 according to predetermined schedule and/or trigger. The memory system 102 can further adapt internal operations, such as by using different trim settings to adjust the threshold voltages, according to the internal operating temperature of the memory system 102 as provided by the internal temperature sensor 190.

### Operational Adjustments

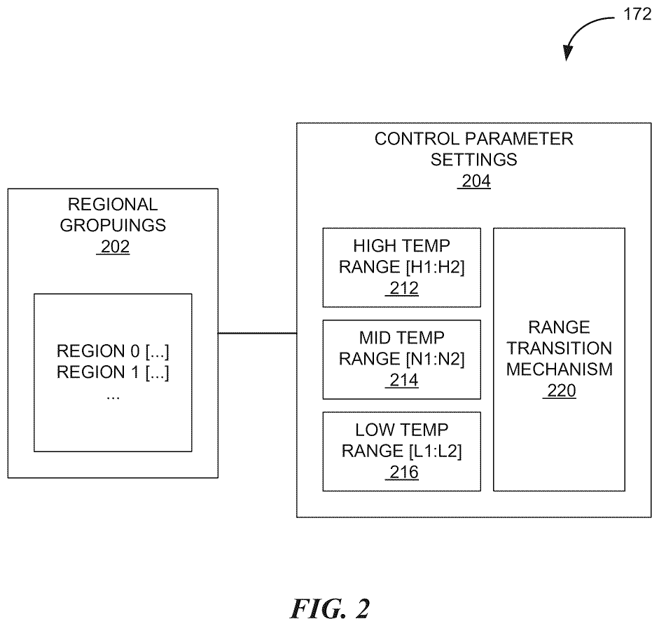

FIG. 2 is an illustration of a control map (e.g., the control map 172) in accordance with an embodiment of the present technology. The control map 172 can include a predetermined relationship between values of the context data 152 of FIG. 1 to corresponding instances of the control parameters 162 of FIG. 1. For example, the control map 172 can include a LUT having regional groupings 202 for matching or assessing the input (e.g., the context data 152). The regional groupings 202 can include geographic locations grouped into regions according to ambient temperatures. Accordingly, the context management mechanism 150 of FIG. 1 can identify the region of the memory system 102 of FIG. 1 based on comparing the location data 154 to the regional groupings 202. Based on the identified region, the context management mechanism 150 can effectively predict or estimate the ambient temperatures and/or extremes thereof and their effects on the operation of the memory system 102.

As an illustrative example, the regional groupings 202 can identify regions having ambient temperatures below a threshold minimum (e.g., −10° C., −20° C., or below), above a threshold maximum (e.g., 40° C. or other ambient temperature associated with higher operating temperature), greater than a threshold difference between high and low, and/or the like. Also, as an example, the regional groupings 202 can identify mountain ranges (e.g., locations with elevations above a threshold range), polar/arctic regions, tropical or equatorial regions, desert regions, and/or the like according to predetermined coordinate values and ranges.

In some embodiments, the regional groupings 202 can further identify the regions according to seasons. The memory system 102 can use the time stamp associated with the GPS data to identify the season and the corresponding ambient temperature ranges.

The control map 172 can include predetermined relationships between the regional groupings 202 and control parameters settings 204 (e.g., values of the control parameters 162). In some embodiments, the control parameters settings 204 can include a higher temperature range 212, a middle temperature range 214, and a lower temperature range 216 that are separated according to predetermined operating temperatures. For example, the higher temperature range 212 can include operating temperatures above 100° C., below 120° C., or both. The lower temperature range 216 can include operating temperatures below −10° C. or a similar threshold value.

The middle temperature range 214 can represent targeted temperature range that is between the higher temperature range 212 and the lower temperature range 216 (e.g., between −10° C. and 100° C.). Accordingly, the memory system 102 can be configured to use targeted operating values (e.g., a default threshold voltage value or a default refresh schedule) or processes when operating in the middle temperature range 214. When operating outside of the middle temperature range 214, the memory system 102 can be configured to use adjusted operating values (e.g., a set trim value for the threshold voltage value or an event-based refresh schedule) or processes.

In some embodiments, the control map 172 can include a range transition mechanism 220 that determines processes when the memory system 102 transitions from one operating temperature range to another. For example, the range transition mechanism 220 can include instructions to determine the tracked operations 184 of FIG. 1 when and while the outputs of the internal temperature sensor 190 of FIG. 1 are outside of the middle temperature range 214. Further, the range transition mechanism 220 can include instructions to implement the remedy mechanism 186 of FIG. 1 (e.g., a memory refresh operation, an error correction operation, or the like) for the tracked operations 184 (at the corresponding memory locations) when the outputs of the internal temperature sensor 190 return into the middle temperature range 214.

### Control Flow

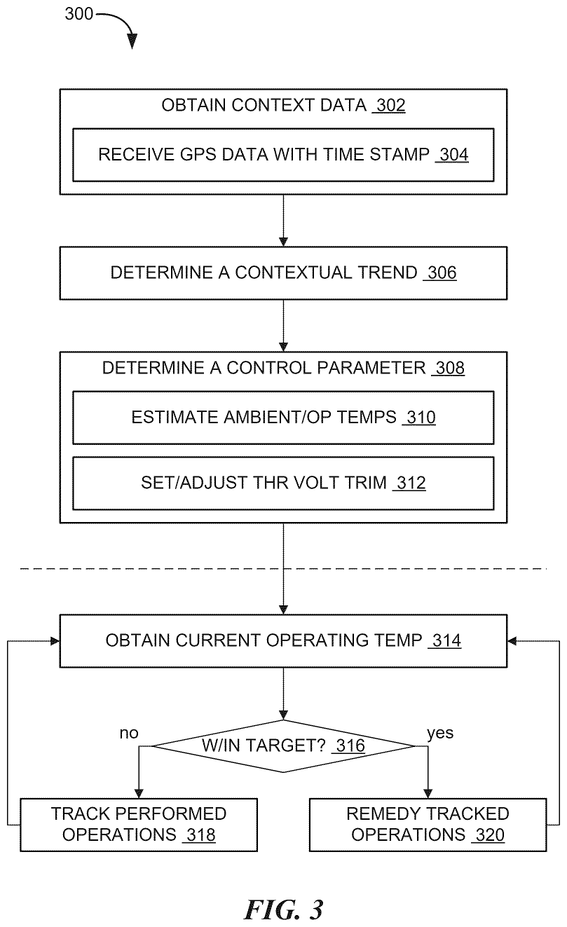

FIG. 3 is a flow diagram illustrating an example method 300 of operating an apparatus (e.g., the memory system 102 of FIG. 1 or one or more components therein) in accordance with an embodiment of the present technology. The example methods can be for implementing the context management mechanism 150 of FIG. 1.

At block 302, the memory system 102 can obtain context data (e.g., the context data 152 of FIG. 1) from the host device 104 of FIG. 1. For example, the memory system 102 can communicate with one or more CPUs for a vehicle management system (e.g., an instance of the computing system 100) to obtain GPS data as illustrated in block 304. The obtained GPS data can have a time stamp.

The memory system 102 can obtain the context data according to a predetermined frequency (e.g., every n hours, every m miles/kilometers, etc.). Additionally or alternative, the memory system 102 can obtain the context data in response to a trigger event, such as (1) a total traveled distance within a given period exceeding a triggering threshold, (2) a first power-on or initialization state, and the like. In some embodiments, the memory system 102 can obtain the context data at least once a day.

The memory system 102 can obtain the context data based on a push mechanism and/or a pull mechanism. For example, the memory system 102 can be configured to send a request for the context data to the host device 104 according to the predetermined frequency and a messaging protocol. Also, the host device 104 can send the context data in response to detecting the triggering event, such as when the vehicle encompassing the computing system 100 travels more than a minimum displacement distance.

Through the context data, the memory system 102 can obtain information representative of one or more conditions surrounding the system (e.g., the vehicle encompassing the computing system 100 of FIG. 1). For example, the location data 154 can effectively represent ambient temperatures for the current geographical location of the memory system 102. Thus, the memory system 102 can use the context management mechanism 150 to estimate and account for the effects of the ambient temperatures on the operating temperatures.

In some embodiments, the memory system 102 can determine a contextual trend (e.g., the context trend 174 of FIG. 1) based on the obtained context data as illustrated in block 306. For example, the memory system 102 use the obtained context data to update a recent set of data (e.g., the currently obtained data with a set of previously obtained data) and compute/update a corresponding statistic value (e.g., a recent maximum/minimum, an average of n highest/lowest readings, variances across each day, etc.). Also, the memory system 102 can use the updated recent set of data to establish a trend across a number of days, such as to determine whether the temperatures are increasing or decreasing. As an illustrative example, the memory system 102 can use the updated recent set of data to determine when average daily temperatures across at least n day windows differ by a minimum number of degrees. Accordingly, the memory system 102 can identify the temperature change characteristic of the vehicle traveling across identified regions (e.g., between or in/out of predetermined geographic or weather regions).

At block 308, the memory system 102 can determine a control parameter (e.g., the control parameter 162) based on the obtained context or the corresponding pattern. Accordingly, the memory system 102 can control an aspect of a memory operation, such as a refresh timing, a processing voltage (e.g., the threshold voltage level), or the like, for the memory device. For example, the memory system 102 can adjust the aspects known affected by the ambient temperature (e.g., through the operating temperature and the resulting device junction temperature (Tj)), such as the threshold voltage level and other related processing levels.

In some embodiments, the memory system 102 can use the obtained context data as an input for the control map 172 of FIG. 1 to compute or output the corresponding control parameter. In doing so, the memory system 102 can effectively estimate, through the control map 172, the ambient and/or operating temperatures likely to occur at the current location of the device as illustrated at block 310. Stated differently the memory system 102 can use the control map 172 to predict whether the expected ambient temperature at the current location of the device is likely to cause the operating temperatures to fall outside of the middle temperature range 214 of FIG. 2.

The memory system 102 may also use the time stamp of the location data 154 as an input to the control map 172. Accordingly, the memory system 102 can account for the seasonal variations in the ambient temperatures for the current device location. For example, in polar regions, the memory system 102 can predict operations in the lower temperature range 216 during winter season (e.g., as predetermined within the control map 172) at some near-polar regions (e.g., Alaska, parts of northern Europe/Canada, southern parts of South America, etc.) while predicting the middle temperature range 214 for the summer and/or other seasons.

In determining the control parameter, the memory system 102 can set or adjust a trim setting, such as to adjust the threshold voltage level or other processing levels, as illustrated at block 312. For example, when the lower temperature range 216 or the higher temperature range 212 of FIG. 2 is expected, the memory system 102 can use a corresponding trim setting for upcoming memory operations (e.g., reads, writes, refresh, etc.). The memory system 102 can use the determined control parameter to perform the memory operations until a new instance of the context data is obtained.

During operation (e.g., before obtaining the next context data), the memory system 102 can obtain a current operating temperature as illustrated in block 314. The memory system 102 can obtain the current operating temperature from the internal temperature sensor 190 of FIG. 1. The memory system 102 can obtain the current operating temperature according to a predetermined frequency/trigger. Accordingly, the memory system 102 can track the current operating temperature during operation.

At decision block 316, the memory system 102 can compare the obtained operating temperature to one or more thresholds that correspond to the temperature ranges 212, 214, and/or 216. In some embodiments, the memory system 102 can update the operating status 182 of FIG. 1 when the operating temperature is outside of the middle temperature range 214 and in the higher temperature range 212 or the lower temperature range 216.

When the current operating temperature is outside of the middle temperature range 214 (e.g., while the operating status 182 indicates outside of the middle temperature range 214), the memory system 102 can logged the performed memory operations and the corresponding locations through the tracked operations 184 of FIG. 1. By predicting such temperature conditions, the memory system 102 can establish the control parameters 162 that are appropriate for the higher/lower operating temperatures. However, when the operating temperature exceeds even the predicted range, the memory system 102 may use the range transition mechanism 220 of FIG. 2 to adjust the control parameter 162 (e.g., the trim settings) to values as predetermined in the control map 172.

In some embodiments, when the current operating temperature subsequently returns within the middle temperature range 214, the memory system 102 can implement remedies for the tracked operations as illustrated in block 320. For example, the memory system 102 can implement a data refresh for addresses that were written/accessed while operating outside of the middle temperature range 214. The memory system 102 can continuously obtain and compare the operating temperatures as illustrated by the feedback loop to block 314.

### Overall System

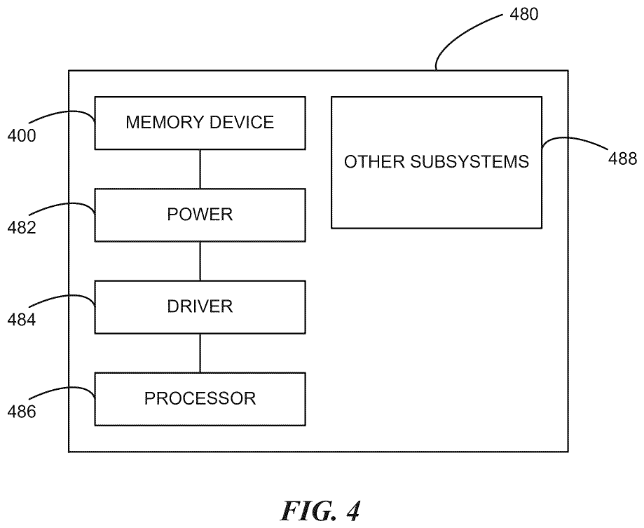

FIG. 4 is a schematic view of a system that includes an apparatus in accordance with embodiments of the present technology. Any one of the foregoing apparatuses (e.g., memory devices) described above with reference to FIGS. 1-3B can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to one or more of the FIGS, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term “processing” as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term “dynamic” as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

I/We claim:

1. A memory device, comprising:
a memory array having rewritable memory cells configured to store data;
a communication interface communicatively coupled to the memory array and configured to communicate with a host device for storing the data provided by the host device, for providing the stored data to the host device, or a combination thereof; and
a memory controller operably coupled to the memory array and configured to:
obtain context data from the host device, wherein the context data represents an external condition surrounding the memory device; and
based on the context data, determine a control parameter according to the context data, wherein the control parameter is configured to control an aspect of a memory operation for the memory device.

2. The memory device of claim 1, wherein the context data includes location data representative of a current geographical location of the memory device.

3. The memory device of claim 2, wherein the location data represents ambient temperatures associated with the current geographical location and having influence on operating temperatures for the memory device.

4. The memory device of claim 3, wherein the controlled aspect associated with the control parameter corresponds to a threshold voltage level that is affected by the operating temperatures.

5. The memory device of claim 4, wherein the control parameter includes a trim setting configured to adjust the threshold voltage level.

6. The memory device of claim 5, wherein:
the memory array includes NAND memory cells; and
the threshold voltage level is for writing the data to and/or reading the data from the NAND memory cells.

7. The memory device of claim 5, wherein the memory device comprises a vehicle management system.

8. The memory device of claim 7, wherein the location data represents a minimum displacement distance for a corresponding vehicle.

9. The memory device of claim 5, wherein:
the location data includes GPS data having a time stamp; and
the control parameter determined according to a season represented by the time stamp.

10. The memory device of claim 3, wherein the memory controller is configured to:
estimate that the ambient temperatures will cause the operating temperatures to fall outside of a targeted range; and
determine the control parameter to use one or more trim settings that correspond to temperatures outside of the targeted range.

11. The memory device of claim 10, further comprising:
an internal sensor configured to provide a current operating temperature;
wherein the memory controller is configured to:
track the current operating temperature;
determine tracked operations that represent memory operations and corresponding memory locations that were implemented while the current operating temperature was outside of the targeted range; and
implement a remedy mechanism for the tracked operations when the current operating temperature subsequently falls within the targeted range.

12. The memory device of claim 11, wherein the remedy mechanism includes a refresh operation to refresh the memory locations associated with the tracked operations.

13. The memory device of claim 12, wherein the targeted range is between 125° C. and −40° C.

14. The memory device of claim 1, wherein the context data includes a vehicle identifier, a driving pattern identifier, or a combination thereof.

15. The memory device of claim 1, wherein the memory controller is configured to:
determine a context trend based on previous and current instances of the obtained context data, wherein the context trend represents a pattern associated with the context data; and
determine the control parameter based on the context trend.

16. A method of operating a memory device within a vehicle management system, the method comprising:
obtaining location data at the memory device from a host device of the vehicle management system, wherein the location data represents a current geographical location of the memory device and estimated ambient temperatures of the current geographical location;
based on the location data, determining a control parameter that adjust an aspect of a memory operation for the memory device.

17. The method of claim 16, wherein determining the control parameter includes determining or adjusting a trim setting according to the location data, wherein the trim setting is for adjusting a threshold voltage level that is affected by an operating temperature of the memory device.

18. The method of claim 16, wherein the location data is obtained according to a predetermined frequency, a trigger event, or a combination thereof.

19. The method of claim 18, wherein the location data is obtained at least once a day.

20. The method of claim 18, wherein the obtained location data represents a vehicle associated with the vehicle management system traveling more than a threshold distance.
